(19) United States
(12) Patent Application Publication
(10) Pub. No.: US 2015/0197708 A1
(43) Pub. Date: Jul. 16, 2015

(54) Fabric Conditioning Composition And Use Thereof

(71) Applicant: Dawei Jin, Shanghai (CN)

(72) Inventor: Dawei Jin, Shanghai (CN)

(73) Assignee: RHODIA OPERATIONS, Paris (FR)

(21) Appl. No.: 14/408,303

(22) PCT Filed: Jun. 18, 2012
(86) PCT No.: PCT/CN2012/077072

§ 371 Date: Dec. 16, 2014

(51) Int. Cl. C11D 3/00; C11D 1/94; C11D 3/16; C11D 1/645

(52) U.S. Cl. CPC C11D 3/001; C11D 1/645; C11D 1/94; C11D 3/162

(57) ABSTRACT

The present invention relates to a composition in order to reduce the residual water content (RWC) of a textile substrate. Said composition comprises at least an amphoteric or cationic or potentially amphoteric or cationic polymer, a cationic softening agent, and a silicone. This composition may be used as a washing composition, by providing an appropriate dilution to the softener composition.

### CROSS-REFERENCE TO RELATED APPLICATIONS

The present application is a U.S. national stage entry under 35 U.S.C. §371 of International Application No. PCT/CN2012/077072 filed Jun. 18, 2012, the whole content of this application being herein incorporated by reference for all purposes.

### FIELD OF THE INVENTION

The present invention relates to a composition in order to reduce the residual water content (RWC) of a textile substrate. Said composition comprises at least an amphoteric or cationic or potentially amphoteric or cationic polymer, a cationic softening agent, and a silicone. This composition may be used as a washing composition, by providing an appropriate dilution to the softener composition.

### BACKGROUND OF THE INVENTION

Water content remaining in fabric or textile substrate, for example clothing, linens or the like, at the end of a washing cycle largely determines the time and energy required to dry consumer bundles of fabrics. The reduction of time and energy in drying laundry has been of great interest to consumers.

U.S. Pat. No. 7,520,013B2 discloses a process for enhancing liquid extraction from fabrics, including the steps of creating a surfactant surface layer including at least one surfactant at an air-liquid interface of the liquid on the fabric, wherein the surface layer has a first surface tension, and adding at least one co-surfactant different from the surfactant. The fabric is then subjected to mechanical extraction for a period of time to reduce the liquid content of the fabric from the first content of liquid to a second liquid content.

US2003/0220217A1 discloses a fabric conditioning composition, comprising a cationic softening agent and a silicone having a viscosity of from 1 to less than 10000 cSt wherein the silicone comprises a cycle polydi-(C₁₋₆)alkyl siloxane, in order to reduce the drying time of laundered fabrics and/or to increase the rate of water removed from the fabrics during the spin cycle of an automatic washing machine.

US2008/0242584A1 discloses a fabric care composition to deliver a softening benefit, comprising a cationic polymer, less than about 20% silicone, a deposition aid, wherein the composition is essentially free of a coacervate, in order to deliver an improved softening benefit to the laundry.

There is a need to provide a fabric conditioning composition to reduce the residual water content RWC of a textile substrate and thus reduce drying time and energy.

### SUMMARY OF THE INVENTION

An object of the invention is to provide a fabric conditioning composition which can effectively reduce the residual water content of a textile substrate; leading then to improve the drying process of the fabric and decrease the drying time thereof.

Another object of the present invention is to provide a use of the fabric conditioning composition in reducing the residual water content of a textile substrate.

In one aspect of the invention, there is provided a softener composition comprising at least:

a) 0.005-5% by weight of the composition of an amphoteric or cationic or potentially amphoteric or cationic polymer having a weight-average molar mass of at least 2000 g/mol, preferably 10,000-10,000,000 g/mol, more preferably 1,000,000-5,000,000 g/mol;
b) 0.005-30% by weight of the composition of a cationic softening agent, and
c) 0.005-50% by weight of the composition of silicone having a viscosity between 10 and 10,000 mPa·s at 25° C.

Said composition of the invention may be used as a washing composition, by providing an appropriate dilution to the softener composition. Dilution with water may be comprised between 0.1 g/L and 20 g/L; more preferably between 1 to 10 g/L; ie as example 1 g of said softener composition in 1 L of water.

In one aspect of the invention, there is preferably provided a washing composition comprising at least water and:

a) 0.0001-0.5% by weight of the composition of an amphoteric or cationic or potentially amphoteric or cationic polymer having a weight-average molar mass of at least 2000 g/mol, preferably 10,000-10,000,000 g/mol, more preferably 1,000,000-5,000,000 g/mol;
b) 0.001-0.5% by weight of the composition of a cationic softening agent, and
c) 0.001-0.1% by weight of the composition of silicone having a viscosity between 10 and 10,000 mPa·s at 25° C.

The present invention also concerns a method to increase drying process of a fabric by using a washing composition as above mentioned.

The present invention also concerns the use of the washing composition as described in reducing the residual water content of a textile substrate.

A fabric according to the invention is a textile article, such as laundry, for example sportwears, towels, clothes, and garments.

### DETAILED DESCRIPTION OF THE INVENTION

### (a) Cationic or Amphoteric or Potentially Cationic or Amphoteric Polymer

As used herein, the term “potentially cationic or amphoteric polymer” means polymer comprising units or groups whose charge may be neutral or cationic depending on the pH.

In one preferred embodiment of the present invention, this polymer has a weight-average molar mass of at least 2000 g/mol, and more preferentially between 1×10⁶ and 5×10⁶ g/mol, depending on their possible degree of polymerization. The weight-average molar masses of the polymers are usually measured by size exclusion. Optionally, they may be measured directly by light scattering or via the intrinsic viscosity using a calibration according to: “Viscosity-Molecular weight relationship, intrinsic chain flexibility and dynamic solution properties of guar galactomannan” by G. Robinson, S. B. Ross Murphy, E. R. Morris, Carbohydrate Research 107, p. 17-32, 1982.

In the present invention, if the weight-average molar mass of the polymer is less than 2000 g/mol, the residual water cannot be removed significantly, and if the weight-average molar mass of the cationic or potentially cationic polymer is greater than 5×10⁶ g/mol, the polymer is difficult to be dissolved.

In one preferred embodiment of the present invention, the polymer (a) may be polysaccharides derivatives as example.

Examples that are mentioned include cationic polysaccharide derivatives, for instance guar, cellulose derivatives, or starch derivatives. Cationic functionalized polymers, functionalized with hydrophobic or hydrophilic groups, for instance C₁-C₁₄ and preferably C₂-C₈ alkyl chains, optionally containing a hydroxyl group, may be used. These groups are attached to the main polymer chain via ether bonds.

Moreover, and in the case of hydrophobic or non-hydrophobic cationic guars, the cationic group is a quaternary ammonium group bearing three radicals, which may be identical or different, chosen from hydrogen and an alkyl radical containing 1 to 22, more particularly 1 to 14 and advantageously 1 to 3 carbon atoms. The counterion may be a halogen, preferably a chlorine.

In the case of hydrophobic or non-hydrophobic modified cationic celluloses, the cationic group is a quaternary ammonium group bearing three radicals, which may be identical or different, chosen from hydrogen and an alkyl radical containing 1 to 10 carbon atoms, more particularly 1 to 6 and advantageously 1 to 3 carbon atoms. The counterion may be halogen, preferably chlorine.

Among the cationic guar derivatives that may be mentioned are guar hydroxypropyl trimonium chloride (Jaguar C13S, C14S, C17 or C500 and Jaguar Excel, sold by the company Rhodia Chimie) or hydroxypropyl guar hydroxypropyl trimonium chloride (Jaguar C162).

Among the cationic cellulose derivatives that may be used are poly(1,2-oxyethanediyl)-2-hydroxy-3-trimethylammonium propyl chloride cellulose ether or polyquaternium-10, or Polymer JR400 (INPI name: PQ10) sold by the company Amerchol.

Nonionic polysaccharide derivatives may also be used, for example hydroxypropyl guar.

The natural cationic polymers more particularly have a weight-average molar mass of at least 2000 g/mol and more preferentially between 2×10⁴ and 3×10⁶ g/mol, depending on their possible degree of polymerization. The weight-average molar masses of the polymers are usually measured by size exclusion. Optionally, they may be measured directly by light scattering or via the intrinsic viscosity using a calibration according to: “Viscosity-Molecular weight relationship, intrinsic chain flexibility and dynamic solution properties of guar galactomannan” by G. Robinson, S. B. Ross Murphy, E. R. Morris, Carbohydrate Research 107, p. 17-32, 1982.

In the case of cationic polysaccharide derivatives, especially guars, the degree of hydroxyalkylation (molar substitution or MS) is preferably between 0 and 1.2. Still in the case of these polymers, the degree of cationicity (degree of substitution or DS) is more particularly between 0.01 and 0.6. This is the case, for example, for Jaguars C162 sold by the company Rhodia Chimie.

Polymer (a) may be also synthetic polymers comprising cationic or potentially cationic groups, and zwitterionic groups. These compounds are notably described in patent application WO 2007/017564.

These polymers may be obtained by (co)polymerization of monomers bearing cationic or potentially cationic or zwitterionic groups, or by modification of polymers after polymerization. In the latter case, this is often referred to correctly or as an abuse of language as cationization, quaternization, derivatization, functionalization or grafting. In the present patent application, a monomer-based unit is understood as being a unit as would be obtained directly by polymerization of said monomer. Thus, a unit that would be obtained by polymerization of a monomer followed by modification does not cover the unit derived from the polymerization of the monomer before modification. On the other hand, such a unit covers the unit that would be obtained by a monomer leading after polymerization to a unit that would have the same formula has the modified unit. In the present patent application, the term “copolymer” covers polymers comprising two types of unit, three types of unit (these are occasionally referred to as terpolymers) or more.

The polymer may be a (co)polymer, which is preferably statistical, chosen from the following:
(co)polymers comprising: cationic or potentially cationic units B_{CAT}, and optionally, other units chosen from anionic or potentially anionic units B_{A}, nonionic units B_{N}, and zwitterionic units B_{Z}, and combinations thereof, or
(co)polymers comprising: zwitterionic units B_{Z}, and optionally, other units chosen from anionic or potentially anionically units B_{A}, hydrophilic or hydrophobic nonionic units BN, and cationic or potentially cationic units B_{CAT}, and combinations thereof.

It is mentioned that copolymers containing both cationic or potentially cationic units B_{CAT} and anionic or potentially anionic units B_{A} are often referred to as amphoteric or ampholytic copolymers. They are occasionally, incorrectly, referred to as zwitterionic polymers. In the present patent application, a zwitterionic (co)polymer denotes a (co)polymer comprising zwitterionic units B_{Z} and optionally other units.

As examples of potentially cationic monomers B_{CAT} from which the potentially cationic units B_{CAT} may be derived, mention may be made of:
α,β-monoethylenically unsaturated carboxylic acid N,N(dialkylamino-ω-alkyl)amides, for instance N,N-dimethylaminomethyl-acrylamide or -methacrylamide, 2(N,N dimethylamino)ethyl-acrylamide or -methacrylamide, 3(N,N-dimethylamino)propyl-acrylamide or -methacrylamide and 4(N,N-dimethylamino)butyl-acrylamide or -methacrylamide;
α,β-monoethylenically unsaturated amino esters, for instance 2(dimethylamino)ethyl acrylate (DAEA), 2(dimethylamino)ethyl methacrylate (DAEMA), 3(dimethylamino)propyl methacrylate, 2(tert-butylamino)ethyl methacrylate, 2(dipentylamino)ethyl methacrylate, or 2(diethylamino)ethyl methacrylate;
vinylpyridines;
vinylamine;
vinylimidazolines;
monomers that are precursors of amine functions such as N-vinylformamide, N vinylacetamide, etc., which generate primary amine functions by simple acid or basic hydrolysis.

As examples of cationic monomers B_{CAT} from which the units B_{CAT} may be derived, mention may be made of:
ammoniumacryloyl or acryloyloxy monomers, for instance:
trimethylammoniumpropyl methacrylate chloride,
trimethylammoniumethylacrylamide or methacrylamide chloride or bromide,
trimethylammoniumbutylacrylamide or methacrylamide methyl sulfate,
trimethylammoniumpropylmethacrylamide methyl sulfate (TAPMA-MES),
(3-methacrylamidopropyl)trimethylammonium chloride (MAPTAC),
(3-acrylamidopropyl)trimethylammonium chloride (APTAC),
methacryloyloxyethyltrimethylammonium chloride or methyl sulfate (MADAMQUAT Cl or MADAMQUAT MeS),
acryloyloxyethyltrimethylammonium chloride; or acryloyloxyethyltrimethylammonium methyl sulfate (ADAMQUAT Cl or ADAMQUAT MeS),
1-ethyl-2-vinypyridinium or 1-ethyl-4-vinylpyridinium bromide, chloride or methyl sulfate;
N,N-dialkyldiallylamine monomers, for instance N,N-dimethyldiallylammonium chloride (DADMAC);
dimethylaminopropylmethacrylamide-N-(3-chloro-2-hydroxypropyl)trimethylammonium chloride (DIQUAT chloride),
dimethylaminopropylmethacrylamide-N-(3-methylsulfato-2-hydroxypropyl)trimethyl [symbol] ammonium methyl sulfate (DIQUAT methyl sulfate)
the monomer of formula:

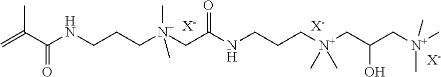

in which X− is an anion, preferably chloride or methyl sulfate.

As examples of hydrophobic nonionic monomers B_{N} from which the hydrophobic units B_{N} may be derived, mention may be made of:
vinylaromatic monomers such as styrene, α-methylstyrene, vinyltoluene, etc.,
vinyl or vinylidene halides, for instance vinyl chloride or vinylidene chloride,
C₁-C₁₂ alkyl esters of α,β-monoethylenically unsaturated acids such as methyl, ethyl or butyl acrylates and methacrylates, 2-ethylhexyl acrylate, etc.,
vinyl or allylic esters of saturated carboxylic acids such as vinyl or allyl acetates, propionates, versatates, stearates, etc.,
α,β-monoethylenically unsaturated nitriles containing from 3 to 12 carbon atoms, for instance acrylonitrile, methacrylonitrile, etc.,
α-olefins, for instance ethylene, etc.,
conjugated dienes, for instance butadiene, isoprene or chloroprene.

As examples of hydrophilic nonionic monomers B_{N} from which the hydrophilic nonionic units B_{N} may be derived, mention may be made of:
hydroxyalkyl esters of α,β-ethylenically unsaturated acids, for instance hydroxyethyl or hydroxypropyl acrylates and methacrylates, glyceryl monomethacrylate, etc.,
α,β-ethylenically unsaturated amides, for instance acrylamide (AM), methacrylamide, N,N-dimethylmethacrylamide, N-methylolacrylamide, etc.,
α,β-ethylenically unsaturated monomers bearing a water-soluble polyoxyalkylene segment of the polyethylene oxide type, for instance polyethylene oxide α-methacrylates (Bisomer S20W, S10W, etc. from Laporte) or α,ω-dimethacrylates, Sipomer BEM from Rhodia (polyoxyethylene ω-behenyl methacrylate), Sipomer SEM-25 from Rhodia (polyoxyethylene ω-tristyrylphenyl methacrylate), etc.,
α,β ethylenically unsaturated monomers that are precursors of hydrophilic units or segments such as vinyl acetate, which, one polymerized, may be hydrolyzed to generate vinyl alcohol units or polyvinyl alcohol segments,
vinylpyrrolidone (VP)
α,β-ethylenically unsaturated monomers of ureido type and in particular 2-imidazolidinoneethylmethacrylamide (Sipomer WAM II from RHODIA).

As examples of anionic or potentially anionic monomers B_{A}, from which the anionic or potentially anionic units B_{A} may be derived, mention may be made of:
monomers containing at least one carboxylic function, for instance α,β-ethylenically unsaturated carboxylic acids or the corresponding anhydrides, such as acrylic, methacrylic or maleic acid or anhydride, fumaric acid, itaconic acid, N-methacroylalanine, or N-acryloylglycine, and the water-soluble salts thereof,
monomers that are precursors of carboxylate functions, for instance tert-butyl acrylate, which generate, after polymerization, carboxylic functions by hydrolysis,
monomers containing at least one sulfate or sulfonate function, for instance 2-sulfoxyethyl methacrylate, vinylbenzenesulfonic acid, allylsulfonic acid, 2-acrylamido-2-methylpropanesulfonic acid, sulfoethyl acrylate or methacrylate, and sulfopropyl acrylate or methacrylate, and the water-soluble salts thereof,
monomers containing at least one phosphonate or phosphate function, for instance vinylphosphonic acid, ethylenically unsaturated phosphate esters such as phosphates derived from hydroxyethyl methacrylate (Empicryl 6835 from Rhodia) and those derived from polyoxyalkylene methacrylates, and the water-soluble salts thereof.

As examples of zwitterionic monomers B_{Z} from which the zwitterionic units B_{Z} may be derived, mention may be made of:
monomers bearing a carboxybetaine group (carboxyalkylammonium in which the alkyl group is optionally substituted with a hydroxyl),
monomers bearing a pyrridinium carboxyalkyl group in which the alkyl group is optionally substituted with a hydroxyl, and
monomers bearing an imidazolium carboxyalkyl group in which the alkyl group is optionally substituted with a hydroxyl.

The overall charge of the polymer for aiding deposition is advantageously positive or zero, at the pH of the concentrated ingredient or at the pH of use of the ingredient.

Polymers that are particularly advantageous are the following (co)polymers:
cationic copolymers comprising units derived from vinylpyrrolidone and cationic units, preferably copolymers comprising vinylpyrrolidone units, vinylimidazolium units (for example cationized vinylimidazole) or MADAMQUAT units (cationized dimethylaminoethyl methacylate), and optionally units derived from vinylcaprolactam,
cationic or ampholytic (co)polymers comprising units derived from DADMAC, optionally units derived from acrylic acid, and optionally units derived from acrylamide,
cationic or ampholytic (co)polymers comprising units derived from MAPTAC, optionally units derived from acrylic acid and optionally units derived from acrylamide,
copolymers derived from vinylpyrrolidone and from MAPTAC;
the copolymers described below as “advantageous copolymers”.

Polymers can be polymers of polyquaternium type according to the INCI terminology familiar to those skilled in the art, chosen, for example, from the polymers of Table 1 below:

TABLE 1

| | | Chemical nature and/or CAS | Commercial |
|---|---|---|---|
| INCI name | Type | number | compounds |
| Polyquaternium-2 | b2 | CAS 63451-27-4 | Mirapol A15, Rhodia |
| Polyquaternium-4 | a1 | CAS 92183-41-0 | Celquat L200, H100, |
| | | | National Starch |
| Polyquaternium-5 | b2 | CAS 26006-22-4 | |
| Polyquaternium-6 | b2 | DADMAC polymer | Merquat 1000, |
| | | CAS 26062-79-3 | Nalco, |
| | | | Mirapol 100, Rhodia |
| Polyquaternium-7 | b2 | Copolymer of DADMAC and | Merquat 5500, |
| | | of acrymide | Nalco; Mirapol 550, |
| | | CAS 26590-05-6 | Rhodia |
| Polyquaternium-10 | a1 | Hydroxyethylcellulose | Polymer JR 400, |
| | | modified with | Amercol; Celquat |
| | | trimethylammoniums | SC230M or |
| | | | SC-240C, National |
| | | | Starch |
| Polyquaternium-11 | b2 | Copolymers of | Gafquat 755N, ISP; |
| | | vinylpyrrolidone and of | Luviquat PQ11PN, |
| | | quaternized | BASF |
| | | dimethylaminoethyl | |
| | | methacylate | |
| Polyquaternium-16 | b2 | CAS 29297-55-0 | Luviquat HM 552, |
| | | | Luviquat FC 370, |
| | | | BASF |
| Polyquaternium-17 | b2 | CAS 90624-75-2 | Mirapol AD1, |
| | | | Rhodia |
| Polyquaternium-19 | b2 | CAS 110736-85-1 | |
| Polyquaternium-22 | b2 | Copolymer of DADMAC and | Merquat 280, 281, |
| | | of acrylic acid | 298, Nalco |
| Polyquaternium-24 | a1 | Hydroxyethylcellulose | Quartisoft LM200, |
| | | modified with quaternary | Amercol |
| | | ammoniums containing long | |
| | | alkyl chains | |
| Polyquaternium-27 | b2 | | Merquat 2001, Nalco |
| Polyquaternium-28 | b2 | Copolymer of vinylpyrrolidone | Gatquat HS 100, |
| | | and of MAPTAC | BASF |
| Polyquaternium-29 | b2 | Chitosan derivative modified | Kytamer KCO, |
| | | with propylene oxide and | Amerchol, |
| | | quaternized with | Lexquat CH |
| | | epichlorohydrin | |
| Polyquaternium-31 | b2 | CAS 136505-02-7 and | Hypan HQ |
| | | 139767-67-7 | |
| Polyquaternium-32 | b2 | CAS 254429-19-7 | |
| Polyquaternium-37 | b2 | CAS 35429-19-7 | |
| Polyquaternium-39 | b2 | | Merquat 3300, 3331, |
| | | | Nalco |
| Pnlyquaternium-44 | b2 | | Luviquat Care, |
| | | | BASF |
| Polyquaternium-46 | b2 | copolymers of | Luviquat Hold, |
| | | vinylcaprolactam, | BASF |
| | | vinylpyrrolidone, and | |
| | | cationized vinylimidazole | |
| Guar | a1 | | Jaguar C13S, C14S, |
| hydroxypropylammonium | | | C17 Excel, Rhodia |
| chloride | | | |
| Hydroxypropyl guar | a1 | | Jaguar C162, Rhodia |
| hydroxypropylammonium | | | |
| chloride | | | |
| Undergoing | a1 | Hydroxy ethylcellulose | Softcat SL, |
| validation | | modified with quaternary | Amerchol |
| | | ammoniums containing long | |
| | | alkyl chains and with | |
| | | short-chain quaternary | |
| | | ammoniums | |
| Polymethacrylamidopropyl- | | MAPTAC polymer | Polycare 133, Rhodia |
| trimonium | | | |
| chloride | | | |
| Acrylamidopropyltrimonium | | | Salcare SC-60, Ciba |
| chloride/acrylamide | | | |
| copolymer | | | |

### (b) Cationic Softening Agent

As used herein, the term of “cationic softening agent” means cationic surfactant which could make a fabric smooth and soft when treated.

In one embodiment of the present invention, the cationic softener is preferably a quaternary ammonium fabric softening material. This softening agent may be considered as a surfactant for the inventive formulation.

Examples of right cationic softening agents of quaternary ammonium types may be for example: ester quaternary ammonium, alkyl quaternary ammonium, amido quaternary ammonium, imidazoline quaternary ammonium, and ester amido quaternary ammonium.

Particularly preferred quaternary ammonium fabric softening materials comprise two C12-28 alkyl or alkenyl groups connected to the nitrogen head group, preferably via at least one ester link. It is more preferred if the quaternary ammonium material has two ester links present.

Preferably, the average chain length of the alkyl or alkenyl group is at least C14, more preferably at least C16. Most preferably at least half of the chains have a length of C18.

It is generally preferred if the alkyl or alkenyl chains are predominantly linear, although a degree of branching, especially mid-chain branching, is within the scope of the invention.

Ester quaternary ammonium compounds may be for example triethanolamine-based quaternary ammonium of formula:

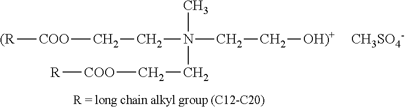

such as:
TET: Di(tallowcarboxyethyl)hydroxyethyl methyl ammonium methylsulfate, R—COOH=tallow acid
TEO: Di(oleocarboxyethyl)hydroxyethyl methyl ammonium methylsulfate, R—COOH=oleic acid
TES: Distearyl hydroxyethyl methyl ammonium methylsulfate, R—COOH=stearic acid
TEHT: Di(hydrogenated tallow-carboxyethyl)hydroxyethyl methyl ammonium methylsulfate, R—COOH=hydrogenated tallow acid
TEP: Di(palmiticcarboxyethyl)hydroxyethyl methyl ammonium methylsulfate, R—COOH=palmitic acid.

There are other examples of cationic softening agents, mentioned in the patent application of CA2653972A1, from page 7 to 11.

### (c) Silicone

As used herein, the terms of “silicone” or “polyorganosiloxane” means any organosiloxane compound comprising alkyl groups (for example methyl) and/or functionalized with groups other than alkyl groups.

Silicone is used in the composition of the invention to make the fiber surface hydrophobic.

The silicone of the present invention can be any silicone comprising compound. In one embodiment, the silicone is a polydialkylsilicone, preferably a polydimethyl silicone (polydimethyl siloxane or “PDMS”) or a derivative thereof. In another embodiment, the silicone is chosen from an aminofunctional silicone, such as alkyloxylated silicone, preferably ethoxylated silicone, propoxylated silicone, ethoxylated/propoxylated silicone, quaternary silicone, or combinations thereof.

In the one preferable embodiment of the invention, the polyorganosiloxane may especially be a polydimethylorganosiloxane (“PDMS”, INCI name: dimethicone) or a polyorganosiloxane containing amine groups (for example Amodimethicone according to the INCI name), quaternary ammonium groups (for example the silicones Quaternium 1 to 10 according to the INCI name), hydroxyl groups (terminal or nonterminal), polyoxyalkylene groups, for example polyethylene oxide and/or polypropylene oxide (as end groups, as a block in a PDMS chain, or as grafts) or aromatic groups, or several of these groups.

The polyorganosiloxanes are preferably present in the concentrated ingredient in emulsion form (liquid droplets of silicone dispersed in the aqueous phase). The emulsion may especially be an emulsion with a mean droplet size of greater than or equal to 2 μm, or with a mean droplet size of between 0.15 μm and 2 μm, or with a mean droplet size of less than or equal to 0.15 μm.

The droplets of the emulsion may be of more or less large size. Reference may thus be made to microemulsions, miniemulsions or macroemulsions. In the present patent application, the term “emulsion” especially covers all these types of emulsion. Without wishing to be bound to any theory, it is pointed out that microemulsions are generally thermodynamically stable systems. The other emulsions are generally systems in thermodynamically unstable state, conserving for a certain time, in metastable state, the mechanical energy supplied during the emulsification. These systems generally comprise smaller amounts of emulsifiers.

The emulsions may be obtained by mixing an outer phase which is preferably aqueous, polyorganosiloxane, polymer for aiding deposition and, in general, an emulsifier, followed by emulsification. This process may be referred to as in-situ emulsification.

Among the water-soluble silicones of the composition that may be mentioned, inter alia, are dimethicone copolyols (Mirasil DMCO sold by the company Bluestar Silicones).

As regards silicones in the form of water-insoluble dispersions or emulsions, nonvolatile water-insoluble organopolysiloxanes may appropriately be used, among which mention may be made of polyalkylsiloxane, polyarylsiloxane, and polyalkylarylsiloxane oils, gums or resins or nonvolatile water-insoluble functionalized derivatives thereof, or mixtures thereof.

Said organopolysiloxanes are considered as being water-insoluble and nonvolatile when their solubility in water is less than 50 g/liter and their intrinsic viscosity is at least 3000 mPa·s, at 25° C.

Examples of nonvolatile water-insoluble organopolysiloxanes or silicones that may be mentioned include silicone gums, for instance the diphenyl dimethicone gum sold by the company Rhodia Chimie, and preferably polydimethylorganosiloxanes with a viscosity at least equal to 6×10⁵ mPa·s, at 25° C., and even more preferentially those with a viscosity of greater than 2×10⁶ mPa·s, at 25° C., such as Mirasil DM 500000® sold by the company Bluestar Silicones.

According to the invention, the nonvolatile water-insoluble organopolysiloxane or silicone is in a form dispersed in the concentrated ingredient containing it.

Among these low-viscosity silicones, mention may be made of cyclic volatile silicones and polydimethylorganosiloxanes of low mass.

It is also possible to use functionalized silicone derivatives, for instance amine derivatives directly in the form of emulsions or starting with a preformed microemulsion. These may be compounds known as amino silicones or hydroxyl silicones. Mention is made, for example, of the oil Rhodorsil amine 21637 (Amodimethicone) sold by the company Rhodia, and dimethiconol.

As polyorganosiloxanes that may be used mention is made especially of:
polyorganosiloxanes comprising units —Si(CH₂)₂O— and units
SiY(CH₂)O— in which Y is a —(CH₂)₃—NH(CH₂)₂—NH₂ or —(CH₂)₃—NH₂ group,
polyorganosiloxanes comprising units —Si(CH₂)₂O— and end units —HO—Si(CH₂)₂O— and/or non-end units —Si(CH₂)(OH)O—
polyorganosiloxanes comprising units —Si(CH₂)₂O— and units —SiY(CH₂)O— in which Y is -L^{X}-Z^{x}-Palk in which L^{X} is a divalent bonding group, preferably an alkyl group, Z^{X} is a covalent bond or a divalent connecting group comprising a heteroatom, Palk is a group of formula [OE]ₛ-[OP]ₜ—X′, in which OE is a group of formula CH₂—CH₂—O—, OP is a group of formula —CH₂—CHCH₃—O— or —CHCH₃—CH₂—O—, X′ is a hydrogen atom or a hydrocarbon-based group, s is a mean number greater than 1, and t is a mean number greater than or equal to 0,
polyorganosiloxanes whose chain comprises at least one block comprising units of formula —Si(CH₂)₂O— and at least one block [OE]ₛ-[OP]ₜ—,
polyorganosiloxanes comprising units —Si(CH₂)₂O— and/or units —Si(CH₂)RO— and/or —SiR₂O— and/or R—Si(CH₂)₂O— and/or H₃C—SiR₂O— and/or R—SiR₂O— in which R, which may be identical or different, is an alkyl group other than a methyl group, an aryl group, an alkyl group, an alkylaryl group or an aralkyl group.

### EXPERIMENTAL PART

Used compounds are the following:
TEP: Di(palmiticcarboxyethyl)hydroxyethyl methyl ammonium methylsulfate, R—COOH=palmitic acid. Fentacare TEP CAS number: 91995-81-. Rhodia Feixiang specialty chemicals co., Ltd
PQ74: polyquaternium. PQ-74 is amphoteric copolymer, bearing both cationic and anionic charges. Cationic charge density of PQ-74 varies from 0 to 1 meq/g as a function of pH. Mirapol PQ 74 from Rhodia
Mirapol 100: Polyquaternium 6, a polymeric quaternary ammonium salt of dimethyl diallyl ammonium chloride, available from Rhodia
Mirapol 550: Polyquaternium 7 (CAS 26590-05-6), available from Rhodia
POS: high molecular weight polyalkylsiloxane of 500 000 cps viscosity.
Jaguar C17: guar hydroxypropyl trimonium chloride. Sold by Rhodia
Aminosilicone: DC2-8194 from Dow corning
FS 222 from SNF Floerger: oil-in-water emulsion composed of cationic polyacrylamine

### Fabric Conditioning Composition Preparation

### Example 1

1) add molten cationic softening agent slowly to the stirred hot water.
2) start to cool down the mixture, at around the melting point, cationic softening agent crystals are formed, viscosity increases, cool down to room temperature.
3) add thickener and stir.
4) add amphoteric or cationic polymer and silicone oil.
5) add fragrance and homogenize.
6) check pH and add citric acid if needed to adjust pH to 2.5-3.8

### Examples 2

According to the same process as that of example 1, a series of formulations are prepared, the components thereof are listed in Table 2.

TABLE 2

| Example | Component | Component | Component | |
|---|---|---|---|---|
| No. | (a) | (b) | (c) | |
| 1 | Jaguar C17 | Fentacare TEP | DC2-8194 | Water |
| | 0.5% | 5% | 5% | to 100% |
| 2 | Jaguar C17 | Fentacare TEP | DC2-8194 | Water |
| | 0.5% | 5% | 2.5% | to 100% |
| 3 | Jaguar C17 | Fentacare TEP | DC2-8194 | Water |
| | 1% | 5% | 2.5% | to 100% |
| 4 | Mirapol PQ74 | Fentacare TEP | DC2-8194 | Water |
| | 1% | 5% | 5% | to 100% |
| 5 | Mirapol PQ74 | Fentacare TEP | DC2-8194 | Water |
| | 10% | 5% | 5% | to 100% |
| 6 | Mirapol PQ74 | Fentacare TEP | POS | Water |
| | 1% | 5% | 4% | to 100% |
| 7 | Mirapol PQ74 | Fentacare TEP | POS | Water |
| | 0.5% | 5% | 2% | to 100% |
| 8 | Mirapol 100 | Fentacare TEP | DC2-8194 | Water |
| | 1% | 5% | 5% | to 100% |
| 9 | Mirapol 550 | Fentacare TEP | DC2-8194 | Water |
| | 1% | 5% | 5% | to 100% |
| 10 | Mirapol PQ74 | Fentacare TEP | DC2-8194 | Water |
| | 1% | 5% | 5% | to 100% |

All formulations of examples are comprising 0.5% wt of FS222

When used in the rinse step of a household washing machine, fabric softener is normally diluted to washing formulation. Hereby the dilution is 2 g/L.

### Example 3

### RWC Measurement

A sample is made: a cotton towel is cut into strips of the same size and then made into rolls tied with cotton thread.

### RWC Testing of Water Treatment

A cotton roll is heated at 90° C. for 30 min to get its dry weight WO. The towel roll is immersed into water for 5 min and then centrifuged at 90 G for 10 min which is similar to household rinse and spin process, then getting the weight of the cotton roll after centrifugation W1.

Water treated residual water content is then RWC0=(W1−W0)/W0

### RWC Testing of Treatment of the Composition According to the Invention

The towel roll is heated at 90° C. for 2 hours to let it totally dry. The towel roll is treated with a solution of set formulation of Table 2 according to the above step and getting the weight of the cotton roll treated with the solution after centrifugation W2.

Solution treated residual water content is then RWC1=(W2−W0)/W0.

The relative residual water content of the cotton roll treated by solution is then RWC=RWC1/RWC0

Then repeating the above steps with other towel rolls, permits to get several RWCs and obtaining an average of these RWCs for analysis.

In testing, a bath heating light is used to heat towel. It is thought that environmental conditions, such as temperature, humidity and wind speed, could influence evaporating rate of water. The bath light here could provide two functions:

1) accelerate evaporating rate and reduce experimental time;
2) increase the temperature and amplify the impact of temperature which could reduce relatively the impact of other two factors.

The experiment of testing of example 1 and control are listed in Table 3.

TABLE 3

| | | |
|---|---|---|
| Exp | Towel strip 1 | Towel strip |
| No. | as control sample | as test sample |

Heat at 90 deg C. to be totally dry

| | | |
|---|---|---|
| 1 | Treated with Water | Treated with Water |
| | and centrifuge | and centrifuge |

Heat at 90 deg C. to be totally dry

| | | |
|---|---|---|
| 2 | Treated with Water | Treated with formulation and |
| | and centrifuge | centrifuge |

Simple mixture of these additives in water at ambient temperature.

Control sample is the same towel strip 1 to indicate environment change. Test sample is also the same towel strip 2. In experiment No. 1, it's treated with water and in No. 2, treated with solution.

According to the series of formulations of Table 2, we get a series of RWC testing data listed in Table 4.

TABLE 4

| WASHING FORMULATION | RWC (%) |
|---|---|
| Comparative trials | |
| Water | 100 |
| 0.01% wt Fentacare TEP | 99.6 |
| 0.01% wt of PQ74 | 108.9 |
| 0.01% wt Fentacare TEP + 0.01% wt aminosilicone | 99 |
| 0.01% wt aminosilicone | 99.2 |
| 0.1% wt Fentacare TEP | 70 |
| 0.01% wt PQ74 + 0.04% wt POS | 78 |
| 0.01% wt Jaguar C17 | 98 |
| Inventive trials | |
| 0.01% wt PQ74 + 0.01% wt aminosilicone + 0.01% wt TEP | 90 |
| 0.001% wt Jaguar C17 + 0.01% wt aminosilicone + 0.01% wt | 71 |
| Fentacare TEP (Example 1) | |
| 0.001% wt Jaguar C17 + 0.005% wt aminosilicone + | 85 |
| 0.01% wt Fentacare TEP (Example 2) | |
| 0.002% wt Jaguar C17 + 0.005% wt aminosilicone + | 75 |
| 0.01% wt Fentacare TEP (Example 3) | |
| 0.01% wt PQ74 + 0.04% wt POS + 0.1% wt Fentacare TEP | 53 |
| (Example 4) | |

It appears then that the composition of the present invention permits to obtain a low residual water content in comparison with formulations of the prior art that do not comprise the same components or different proportions of components; leading then to improve the drying process of the fabric and decrease the drying time.

All documents cited in the Detailed Description of the Invention are, in relevant part, incorporated herein by reference. It should be understood that every numerical range given throughout this specification will include every narrower numerical range that falls within such broader numerical range, as if such narrower numerical ranges were all expressly written herein. All parts, ratios and percentages herein, in the specification, examples and claims, are by weight and all numerical limits are used with the normal degree of accuracy afforded by the art, unless otherwise specified. While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A softener composition comprising at least:
a) 0.005-5% by weight of the composition of an amphoteric or cationic or potentially amphoteric or cationic polymer having a weight-average molar mass of at least 2000 g/mol,
b) 0.005-30% by weight of the composition of a cationic softening agent, and
c) 0.005-50% by weight of the composition of silicone having a viscosity between 10 and 10,000 mPa·s at 25° C.

2. A washing composition comprising at least water and:
a) 0.0001-0.5% by weight of the composition of an amphoteric or cationic or potentially amphoteric or cationic polymer having a weight-average molar mass of at least 2000 g/mol,
b) 0.001-0.5% by weight of the composition of a cationic softening agent, and
c) 0.001-0.1% by weight of the composition of silicone having a viscosity between 10 and 10,000 mPa·s at 25° C.

3. The composition of claim 1, wherein the cationic polymer or potentially cationic polymer having a weight-average molar mass of between 1×10⁴ and 10×10⁶ g/mol.

4. The composition of claim 1, wherein the cationic polymer or potentially cationic polymer is polysaccharides.

5. The composition of claim 1, wherein the cationic polymer or potentially cationic polymer is selected from the group consisting of guar, cellulose derivatives, starch derivatives and combinations thereof.

6. The composition of claim 1, wherein the silicone is selected from the group consisting of a polydialkylsilicone and derivative thereof.

7. The composition of claim 1, wherein the silicone is selected from the group consisting of an aminofunctional silicone.

8. The composition of claim 1, wherein the cationic softening agent is a quaternary ammonium.

9. The composition of claim 1, wherein the cationic softening agent is selected from the group consisting of an ester quaternary ammonium, an alkyl quaternary ammonium, an amido quaternary ammonium, an imidazoline quaternary ammonium and ester amido quaternary ammonium.

10. The composition of claim 1, wherein the cationic softening agent is a quaternary ammonium comprising two C12-28 alkyl or alkenyl groups connected to the nitrogen head group.

11. The composition of claim 10, wherein the two C12-28 alkyl or alkenyl groups are connected to the nitrogen head group via at least one ester link.

12. The composition of claim 10, wherein the two C12-28 alkyl or alkenyl groups are connected to the nitrogen head group via two ester links.

13. A method to reduce the residual water content of a textile substrate comprising a step of using a washing composition according to claim 2.

14. A method to increase drying process of a fabric by using a washing composition according to claim 2.

15. The softener composition of claim 1, wherein said amphoteric or cationic or potentially amphoteric or cationic polymer having a weight-average molar mass of at least 10,000-10,000,000 g/mol.

16. The softener composition of claim 1, wherein said amphoteric or cationic or potentially amphoteric or cationic polymer having a weight-average molar mass of at least 1,000,000-5,000,000 g/mol.

17. The composition of claim 2, wherein the cationic polymer or potentially cationic polymer having a weight-average molar mass of between 1×10⁴ and 10×10⁶ g/mol.

18. The composition of claim 2, wherein the cationic polymer or potentially cationic polymer is selected from the group consisting of guar, cellulose derivatives, starch derivatives and combinations thereof.

19. The composition of claim 2, wherein the silicone is selected from the group consisting of a polydialkylsilicone and derivative thereof.

20. The composition of claim 2, wherein the cationic softening agent is a quaternary ammonium.
